(19) United States
(12) Patent Application Publication
(10) Pub. No.: US 2019/0065919 A1
(43) Pub. Date: Feb. 28, 2019

(54) Payment Card With Integrated Biometric Sensor And Power Source

(71) Applicant: MASTERCARD ASIA/PACIFIC PTE. LTD., Singapore (SG)

(72) Inventors: Rajat Maheshwari, Singapore (SG); Sumeet Bhatt, Jericho, NY (US)

(21) Appl. No.: 16/110,796

(22) Filed: Aug. 23, 2018

(30) Foreign Application Priority Data
Aug. 28, 2017 (SG) 10201707019S

(51) Int. Cl. G06K 19/07; G06Q 20/34; G06Q 20/40

(52) U.S. Cl. CPC G06K 19/0718; G06K 19/0701; G06Q 20/40145; G06Q 20/352

(57) ABSTRACT

The present disclosure provides a payment card which utilizes solar energy to power a biometric sensor on the card, the biometric sensor being for authenticating the user of the payment card. By utilizing solar energy, the additional load due to the biometric sensor can therefore be accommodated by supplementing, via a solar power source, the power deliverable by a payment terminal, thus potentially increasing the reliability of biometric authentication during use of the payment card. Other embodiments may utilize other power source types as will be apparent from the following discussion.

### CROSS REFERENCE TO RELATED APPLICATION

This application claims the benefit of and priority to Singapore Patent Application No. 10201707019S filed Aug. 28, 2017. The entire disclosure of the above application is incorporated herein by reference.

### FIELD

The present disclosure generally relates to payment card technologies, and in particular embodiments may relate to a payment card having an integrated biometric sensor and power source, a payment terminal configured to cooperate with the payment card, a payment system including the payment card and payment terminal, and a corresponding payment card authentication process.

### BACKGROUND

This section provides background information related to the present disclosure which is not necessarily prior art.

Payment cards have become ubiquitous in today's society, and continue to replace cash and checks as the preferred means for making financial transactions between merchants and their customers. However, the substantial benefits for customers, merchants and financial institutions are offset to some extent by risks of card theft and fraud. In order to improve the security of payment cards, they are now provided with a ‘Card Verification Value’ or CVV number printed on their face, the theory being that the CVV number can only be provided by a person in possession of the payment card. However, this provides a relatively weak degree of protection, since theft or close observation of a payment card is sufficient to allow fraudulent use of the accounts associated with the card in payment transactions.

In order to further improve the security of payment cards, fingerprint scanners have recently been incorporated into some point-of-sale (POS) terminals. Thus an authorized user of a payment card can register at least one fingerprint during an enrollment or registration process at an earlier juncture prior to being at the POS terminals by placing at least one of their fingers on a fingerprint scanner. The enrollment or registration process can be carried out by the financial institution or a proxy which issues the payment card. The fingerprint scanner generates an image of the user's fingerprint, and this image is then subjected to a process referred to in the art as ‘feature extraction’ to determine characteristics or ‘features’ of the fingerprint that in combination provide a unique identifier of the user. Following the enrollment process, the extracted features constitute a fingerprint template that is stored in a template database. During a payment card transaction, the user may be prompted to scan their fingerprint using the scanner of the POS terminal, and the scanned fingerprint is then subjected to a corresponding feature extraction process at the POS terminal. The payment card transaction is authorized to proceed only if the two fingerprint templates (the stored template, retrieved from the template database, and the freshly generated template) are a matching pair; otherwise, the transaction is declined.

Despite the significant advances made in these areas, there remains room for improvement.

It is desired to overcome or at least alleviate one or more difficulties of the prior art, or to at least provide a useful alternative.

### SUMMARY

This section provides a general summary of the disclosure, and is not a comprehensive disclosure of its full scope or all of its features. Aspects and embodiments of the disclosure are set out in the accompanying claims.

In a first aspect, there is provided a payment card, including: a processor; a non-volatile memory storing instructions to be executed by the processor; a biometric sensor; a power source in communication with the biometric sensor; a volatile memory to temporarily store data from the biometric sensor when the volatile memory is energized by the power source; and a data transfer interface in communication with the volatile memory and the non-volatile memory, the data transfer interface being configured to transmit the data from the biometric sensor to an external reader device.

It will be appreciated that the broad forms of the disclosure and their respective features can be used in conjunction, interchangeably and/or independently, and reference to separate broad forms is not intended to be limiting.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, some embodiments of the present disclosure are hereinafter described, by way of example only, with reference to the accompanying drawings, in which like elements have the same reference numerals, and wherein:

FIGS. 1A and 1B include an illustration and block diagram respectively of a payment card having an integrated biometric sensor and power source in accordance with embodiments of the present disclosure;

FIG. 2 is a flow diagram of a payment process in accordance with some embodiments of the present disclosure;

FIG. 3 is a block diagram showing components of a payment system, including the payment card of FIG. 1 and a payment terminal configured to cooperate with the payment card;

FIG. 4 is a schematic diagram showing components of an example point of sale (POS) device of the system shown in FIG. 3; and

FIG. 5 is a schematic diagram showing components of an example server shown in FIG. 3.

The same numerals represent the same or similar elements throughout the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

Embodiments of the present disclosure provide a payment card which utilizes solar energy to power a biometric sensor on the card, the biometric sensor being for authenticating the user of the payment card. Biometric sensors consume more power than conventional electronic components of smart cards, which would typically be powered by a reader such as a payment terminal. By utilizing solar energy, the additional load due to the biometric sensor can therefore be accommodated by supplementing, via a solar power source, the power deliverable by a payment terminal, thus potentially increasing the reliability of biometric authentication during use of the payment card. Other embodiments may utilize other power source types as will be apparent from the following discussion.

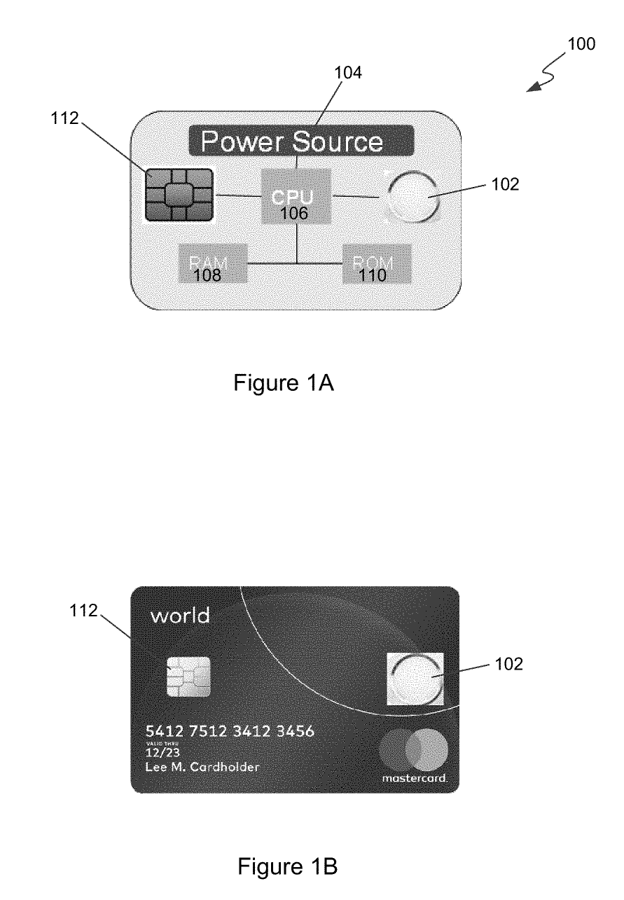

As shown in FIGS. 1A and 1B, a payment card 100 includes an integrated sensor 102 and power source 104, at least one processor 106, volatile memory (RAM) 108, non-volatile memory 110, and interface 112 that allow communication between the payment card 100 and external devices or systems. In some embodiments, the interface 112 comprises electrical contacts. In other embodiments, the interface 112 comprises a wireless transceiver, for example, an NFC transceiver.

The integrated sensor 102 senses biometric information of a user of the payment card 100. In the described embodiments, the sensor 102 is a fingerprint scanner; however, other types of sensor capable of acquiring biometric information of the user could be used in addition, or as alternatives; for example, a microphone for use with voiceprint recognition, or an imaging sensor for acquiring an image of a user's face or iris. Other types of biometric sensors capable of being integrated into the payment card 100 will be apparent to those skilled in the art in light of this disclosure.

The powered components of the payment card 100, including the processor 106 and volatile memory 108, are powered by electrical energy supplied by the power source 104, which includes an energy transducer that generates electrical power. In some embodiments, it is also possible for the powered components of the payment card 100 to be powered by a point-of-sale (POS) terminal when the payment card 100 is coupled with the POS terminal. It should be appreciated that coupling the payment card 100 with the POS terminal can relate to the act of inserting the payment card 100 into a card reading interface of the POS terminal, correspondingly establishing electrical pathways between the payment card 100 and the POS terminal via the interface (via electrical contacts) of the payment card 100 and corresponding electrical contacts of the POS terminal, allowing the payment card 100 and the POS terminal to exchange data and/or allow transmission of power to the payment card 100, and thus communicate with one another and/or power the payment card 100.

The volatile memory 108 is configured to temporarily store data from the integrated sensor 102 when the volatile memory 108 is powered by the power source 104, and the power source 104 is in communication with the integrated sensor 102. However, the power source 104 may also include associated power supply components, such as a capacitor and/or battery for voltage management and short-term storage of energy generated from the energy transducer. In the described embodiments, the energy transducer 104 is a photovoltaic device; however, other forms of energy transducer, such as, for example, motion induced energy transducers that are capable of supplying sufficient electrical power to at least partially power a biometric matching process during a transaction using the payment card 100.

In some embodiments, the volatile memory 108 is configured to temporarily store data from the integrated sensor 102 when the volatile memory 108 is powered by the POS terminal.

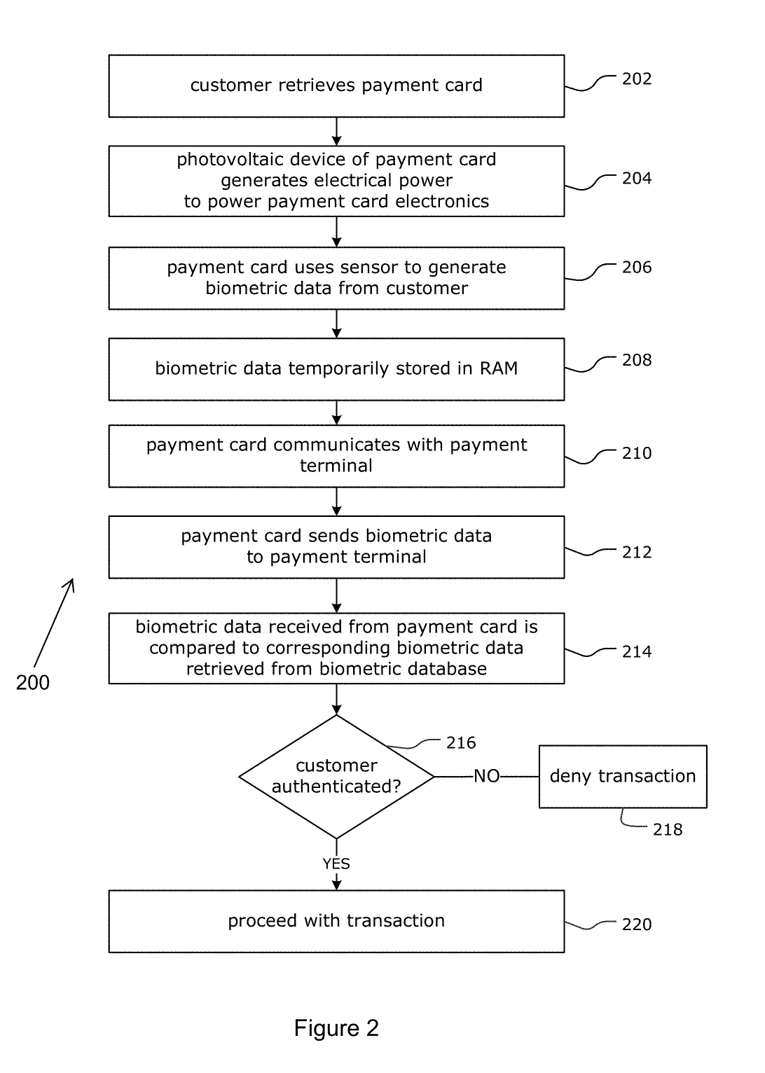

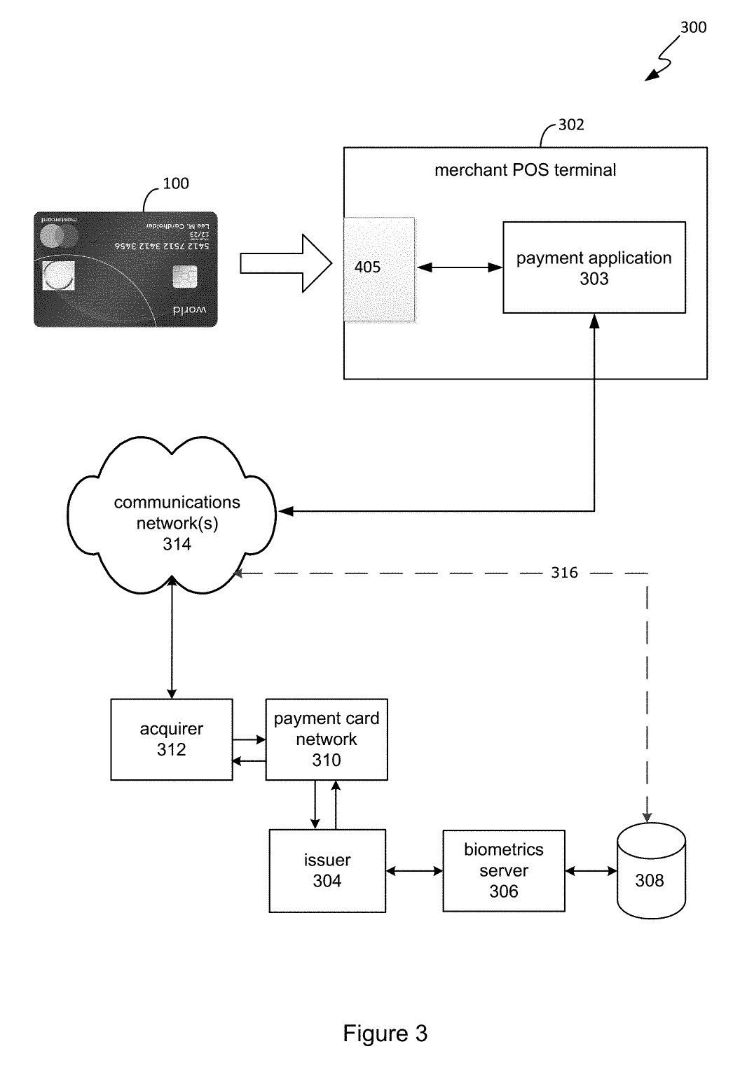

FIG. 2 is a flow diagram of a payment card process 200 that illustrates use of the payment card 100 in authorizing a payment card-based transaction using a payment point-of-sale (POS) terminal 302 and other components of a payment system 300, as shown in FIG. 3. The payment system 300 includes at least one server of an issuing organization or ‘issuer’ (typically, a bank) including or at least having access to a biometric server 306 with associated biometrics database 308, a private payment card network (such as Mastercard™) 310, and at least one server of an acquiring organization or ‘acquirer’ (typically, a merchant's bank) 312 which is communicatively coupled to the payment terminal 302 via a communications network 314, such as the Internet. It should be noted that the payment POS terminal 302 can be of known types which are already in use. It may be necessary for a payment application 303 to be updated such that the payment card 100 is usable in a desired manner, particularly the biometric authentication aspect.

### POS Terminal 302

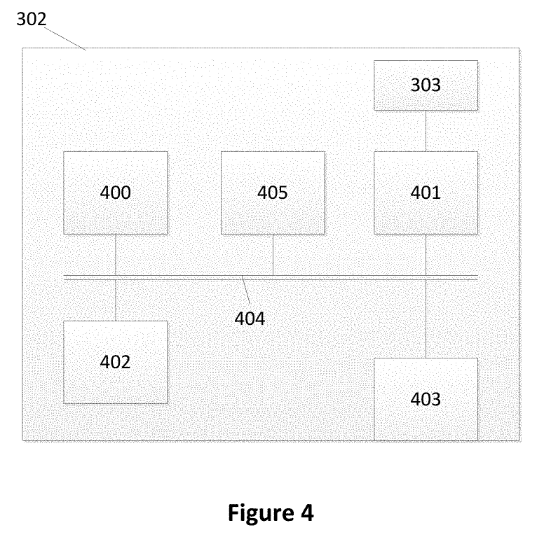

A suitable POS terminal 302 for use in the payment system 300 is shown in FIG. 4.

In this example, the POS terminal 302 includes at least one microprocessor 400, a memory 401, an optional input/output device 402, such as a display, keyboard, touchscreen and the like, a card reading interface 405 and an external interface 403, interconnected via a bus 404 as shown. In this example the external interface 403 can be utilized by the POS terminal 302 when communicating with peripheral devices, such as the communications network 314. Although only a single interface 403 is shown, this is for the purpose of example only, and in practice multiple interfaces using various methods (e.g., Ethernet, serial, USB, wireless, Bluetooth™ Low Energy (BLE), Near Field Communication (NFC), or the like) may be provided.

In use, the microprocessor 400 executes instructions in the form of payment applications software 303 stored in the memory 401 to allow communication with the payment card 100, for example to receive biometric user information, and the acquirer server 312, for example to initiate payment authorization. The applications software may include one or more software modules, and may be executed in a suitable execution environment, such as an operating system environment, or the like.

Accordingly, it will be appreciated that the POS terminal 302 may be formed from any suitable processing system, such as any electronic processing device, including a microprocessor, microchip processor, logic gate configuration, firmware optionally associated with implementing logic, such as an FPGA (Field Programmable Gate Array), or any other suitably configured electronic device, system or arrangement. However, the POS terminal 302 may also be formed from a suitably programmed PC, Internet terminal, lap-top, or hand-held PC, a tablet, or smart phone, or the like. Thus, in one example, the POS terminal 302 is a standard processing system, such as an Intel Architecture based processing system, which executes software applications stored on non-volatile (e.g., hard disk) storage, although this is not essential.

### Issuer Server 304 and Acquirer Server 312

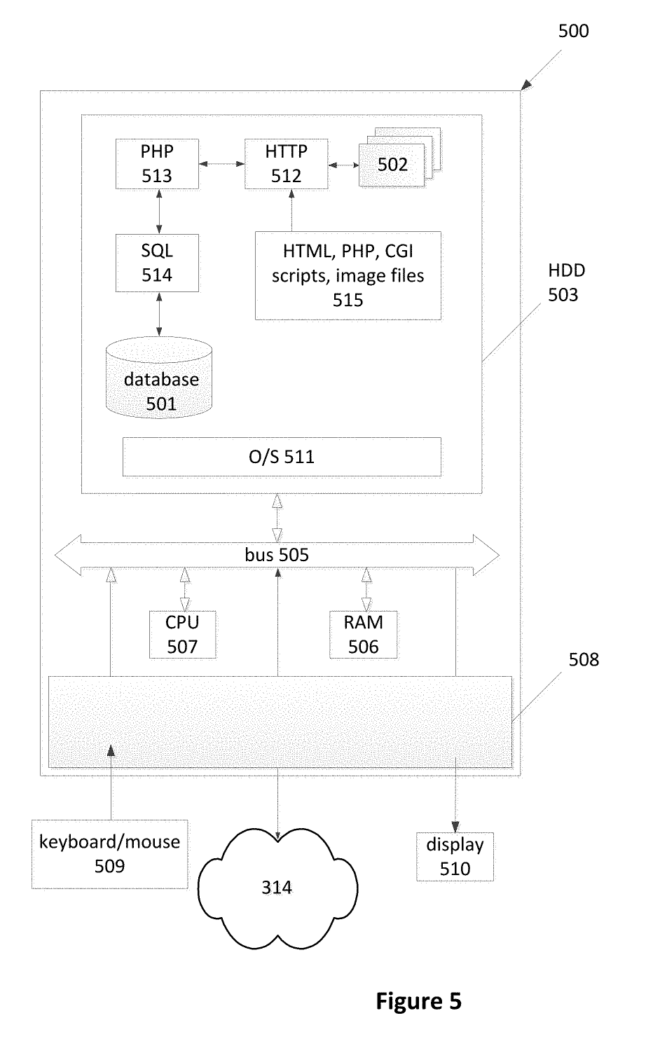

The issuer server 304 and the acquirer server 312 of any of the examples herein may be formed of any suitable processing device, and one such suitable device is shown in FIG. 5.

In this example, a processing device is provided by a server 500 in communication with a database 501, as shown in FIG. 5. The server 500 is able to communicate with the POS terminal 302, and/or other processing devices, as required, over a communications network 314 using standard communication protocols.

The components of the server 500 can be configured in a variety of ways. The components can be implemented entirely by software to be executed on standard computer server hardware, which may comprise one hardware unit or different computer hardware units distributed over various locations, some of which may require the communications network 314 for communication. A number of the components or parts thereof may also be implemented by application specific integrated circuits (ASICs) or field programmable gate arrays.

In the example shown in FIG. 5, the server 500 is a commercially available server computer system based on a 32 bit or a 64 bit Intel architecture, and the processes and/or methods executed or performed by the computer system 500 are implemented in the form of programming instructions of one or more software components or modules 502 stored on non-volatile (e.g., hard disk) computer-readable storage 503 associated with the server 500. At least parts of the software modules 502 could alternatively be implemented as one or more dedicated hardware components, such as application-specific integrated circuits (ASICs) and/or field programmable gate arrays (FPGAs).

The server 500 includes at least one or more of the following standard, commercially available, computer components, all interconnected by a bus 505:
(1) random access memory (RAM) 506;
(2) at least one computer processor 507, and
(3) external computer interfaces 508:
   (a) universal serial bus (USB) interfaces 508.1 (at least one of which is connected to one or more user-interface devices, such as a keyboard, a pointing device (e.g., a mouse 509 or touchpad),
   (b) a network interface connector (NIC) 808.2 which connects the server 500 to a data communications network 314; and
   (c) a display adapter 508.3, which is connected to a display device 510, such as a liquid-crystal display (LCD) panel device.

The server 500 includes a plurality of standard software modules, including:
(1) an operating system (OS) 511 (e.g., Linux or Microsoft Windows);
(2) web server software 512 (e.g., Apache, available at http://www.apache.org);
(3) scripting language modules 513 (e.g., personal home page or PHP, available at http://www.php.net, or Microsoft ASP); and
(4) structured query language (SQL) modules 514 (e.g., MySQL, available from http://www.mysql.com), which allow data to be stored in and retrieved/accessed from an SQL database.

Together, the web server 512, scripting language 513, and SQL modules 514 provide the computer system 500 with the general ability to allow users of the network 314 with standard computing devices equipped with standard web browser software to access the server 500 and in particular to provide data to and receive data from the database 501. It will be understood by those skilled in the art that the specific functionality provided by the server 500 to such users is provided by scripts accessible by the web server 512, including the one or more software modules 502 implementing the processes performed by the server 500, and also any other scripts and supporting data 515, including markup language (e.g., HTML, XML) scripts, PHP (or ASP), and/or CGI scripts, image files, style sheets, and the like.

The boundaries between the modules and components in the software modules 502 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the disclosure. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the steps of the processes performed by the server 500 may be executed by a module (of software modules 502) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 500 normally processes information according to a program (a list of internally stored instructions such as a particular application program and/or an operating system) and produces resultant output information via input/output (I/O) devices 508. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

In order to use the payment system 300, an authorized user of a payment card 100 first provides their biometric information to the issuer 304 during a registration process so that the user's biometric information, or at least corresponding information derived from it, can be stored in the biometrics database 308. Thus in the described embodiment, the authorized user places one of their fingers on a fingerprint scanner. In the described embodiment, the fingerprint scanner used for registration is at a fixed location, namely at a branch office of the issuing organization, but alternatively can be the sensor 302 on the user's own payment card 100 if used under secure conditions (e.g., registration can only be performed while the user's payment card 100 remains inserted into a card reader configured to perform secure registration and located at a branch office of the issuing organization). In an instance when the user's payment card 100 is inserted into the card reader, the payment card 100 can either partially or fully power the extracting of the user's fingerprint image at the sensor 302.

In the described embodiment, standard feature extraction is applied to the image of the user' s fingerprint, and the resulting extracted features are stored in the database as the biometric information of the user. However, it will be apparent to those skilled in the art that the biometric information stored in the database can take any of a variety of different forms. For example, the biometric information could be stored as a one-way hash of the extracted features of the user's fingerprint. Many other possible forms will be apparent to those skilled in the art in light of this disclosure.

Having registered their biometric information (or corresponding information derived from it), the payment card 100 can now be used to make and authorize transactions using a transaction process 200, as shown in FIG. 2. Typically, but not necessarily, each transaction will involve the user making a financial payment to a merchant in exchange for the purchase of goods and/or services from the merchant. In that context, after choosing the goods and/or services, the customer is ready to initiate the transaction, and at step 202 retrieves their payment card 100 (e.g., from a wallet or purse).

In the described embodiment, where the power source 104 includes a photovoltaic device, when the customer retrieves their payment card 100, the ambient light (which can be natural and/or artificial) interacts with the exposed photovoltaic device 102 of the payment card 100 at step 204 to generate electrical power that powers up the components of the payment card 100, including the processor 106 and volatile memory 108, at step 204. On boot up, the processor 106 executes instructions stored in the non-volatile memory 110 which place the processor 106 and fingerprint scanner 102 in a state ready to detect the placement of a finger on the fingerprint scanner 102.

In order to authenticate the user as an authorized user of the payment card 100, the user places a finger (whose fingerprint has previously been registered with the payment system 300 as described above) on the fingerprint scanner 102 of the payment card 100. In response, at step 206 the processor 106 and fingerprint scanner 102 generate biometric data corresponding to the user's fingerprint, and the processor 106 stores it (temporarily) in the random access memory (RAM) 108 of the payment card 100 at step 208.

Having now generated the biometric data that (at least nominally) uniquely identifies the user, the user then enables communication between the payment card 100 into the merchant's payment terminal 302 at step 210. In some embodiments, the communication can be carried out by the act of inserting the payment card 100 into the payment terminal 302 at card reading interface 405 establishes electrical pathways between the payment card 100 and the payment terminal 302 via the interface 112 (via electrical contacts) of the payment card 100 and corresponding electrical contacts of the payment terminal 302, allowing the payment card 100 and the payment terminal 302 to exchange data and/or allow transmission of power to the payment card 100, and thus communicate with one another and/or power the payment card 100.

In other embodiments, the communication can be carried out by the act of locating the payment card 100 in close proximity to the merchant's payment terminal 302 such that a wireless transmission of data can be carried out via the interface 112 (via an NFC transceiver) of the payment card 100 and a receiver of the payment terminal 302. The data can include the user's biometric information.

At step 212, the payment card 100 sends the user's biometric information to the payment terminal 302. In some embodiments, the biometric information may be sent to the payment terminal 302 in encrypted form.

In the described embodiment, the biometric data is received from the payment card 100 in the form of a digital image of the user's fingerprint, although this need not be the case in other embodiments.

In the described embodiment, the user's biometric data and a unique identifier associated with the payment card 100 (e.g., the primary account number (PAN) associated with the payment card 100) is sent to the biometrics server 306, via the communications network 314 and either the acquirer 312, the payment card network 310, and the issuer 304, or directly, as represented by the dashed line 316. If the biometric data is sent in encrypted form, then it is decrypted by the biometrics server 306. In some embodiments, only the unique identifier associated with the payment card 100 is sent to the biometrics server 306.

In some embodiments, as soon as the payment card 100 sends the user's biometric data and the unique identifier to the payment terminal 302, the payment card processor removes the biometric data from the RAM 108 of the payment card 100.

In either case, the unique identifier (e.g., the user's PAN) is used by the biometrics server 306 to retrieve biometric data associated with the payment card 100 and representing or corresponding to at least one fingerprint of a registered user of the payment card 100. If the biometrics server 306 received the user's biometric data from the payment terminal 302, then at step 214, the biometrics server 306 processes the user's biometric data and the biometric data of a registered user of the payment card 100 to determine whether they match or at least correspond such that the user is determined to be (or not to be) a registered user of the payment card 100 (or at least to a high degree of confidence). Alternatively, if the payment terminal 302 did not send the user's biometric data, then the comparison or processing step 214 is performed by the payment terminal 302, albeit at the expense of communicating biometric data of the registered user of the payment card 100, even if in encrypted form.

As described above, in the described embodiment the user's biometric data is received by the biometrics server 306 in the form of a digital image of the user's fingerprint, and the biometrics server 306 processes this image by performing standard feature extraction known to those skilled in the art in order to generate corresponding biometric data in the form of the features extracted from the digital image. The biometric data of the registered user of the payment card stored in the biometrics database 308 is already in this form, and the two sets of biometric data are compared using standard methods known to those skilled in the art.

If the verification step 214 determines that the biometric data of the registered user of the payment card 100 matches the biometric data generated by the payment card 100, then the user is deemed to be authenticated at step 216, then the payment card transaction can proceed at step 220 (where standard steps known to those skilled in the art, including the issuer 304 checking the user's account balance to determine whether the transaction can proceed) are performed. Otherwise, if the user was not authenticated at step 216, then the transaction is declined at step 218.

The data indicative of results of the biometric verification process may comprise the following:
(1) Biometrics matching (e.g., 2 bits)
   (a) Whether the match was being carried out on a remote server;
   (b) Whether the match was being carried out on a biometric card (i.e., a card having at least one biometric sensor);
   (c) Whether the match was being carried out on a payment terminal.
(2) Biometrics template stored (e.g., 2 bits)
   (a) Whether the template/image is being stored on server;
   (b) Whether the template/image is being stored on a biometric card.
(3) Best available match used (e.g., 1 bit)
   (a) Whether multiple fingerprints registered, and if the best matching biometric (e.g., best available fingerprint) was used.
(4) Rating of the authentication mechanism for device/card (e.g., 2 bits)
   (a) Whether the sensor has been approved by an approval authority (e.g., issuer, payment network such as Mastercard™, or third party device approver) (False Match Rate/False Negative Match Rate figures meeting requirements);
   (b) Whether the sensor/device has not been approved by the approval authority (False Match Rate/False Negative Match Rate figures not meeting requirements);
   (c) Whether only security evaluation done, no functional evaluation performed;
   (d) Where no evaluation is performed.

In some embodiments, when the payment card 100 is removed from the payment terminal 302, the processor removes the biometric data from the RAM 108 of the payment card 100 (if it was not already removed as soon as it was sent to the payment terminal 302 as described above). In other embodiments, and in any case, all contents of the payment card's RAM 108 are cleared when the RAM 108 is no longer powered by the power source 104, typically when the user returns the payment card 100 into his or her pocket or wallet or purse. In all of these embodiments, the user's biometric data is generated independently by the payment card 100, and is only stored by the payment card 100 for a brief period of time while the biometric data is being used to authenticate the user and thus authorize a payment card transaction.

It will be apparent that the self-powered payment card described herein provides numerous advantages over existing payment cards, including the ability to acquire biometric data without having to insert the payment card into a payment terminal or other device, while leaving the authentication of that biometric data to a payment terminal or other device. Where the energy source of the payment card is a photovoltaic device, these devices are typically more reliable and longer lived than batteries, thus reducing the need to replace payment cards and thus reducing cost and plastic waste.

Many modifications will be apparent to those skilled in the art without departing from the scope of the present disclosure.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A payment card, including:
a processor;
a non-volatile memory storing instructions to be executed by the processor;
a biometric sensor;
a power source in communication with the biometric sensor;
a volatile memory to temporarily store data from the biometric sensor when the volatile memory is energized by the power source; and
a data transfer interface in communication with the volatile memory and the non-volatile memory, the data transfer interface being configured to transmit the data from the biometric sensor to an external reader device.

2. The payment card of claim 1, wherein the stored instructions, when executed by the processor, cause the processor to:
transmit an instruction to the biometric sensor to generate data representing extracted biometric information of the user;
temporarily store in the volatile memory data representing the extracted biometric information of the user; and
send data representing the extracted biometric information of the user from the payment card to the external reader device for feature extraction to determine whether the user is an authorized user of the payment card.

3. The payment card of claim 1, wherein the power source comprises a transducer to generate electrical energy.

4. The payment card of claim 3, wherein the transducer comprises a photovoltaic device.

5. The payment card of claim 3, wherein the power source further comprises a battery to store at least some of the electrical energy from the transducer.

6. The payment card of claim 1, wherein the data transfer interface comprises a plurality of electrical contacts configured to contact corresponding electrical contacts of the card-reader device.

7. The payment card of claim 1, wherein the data transfer interface comprises a wireless transceiver, the wireless transceiver being an NFC transceiver.

8. The payment card of claim 1, wherein the biometric sensor includes a fingerprint scanner.

9. The payment card of claim 8, wherein the biometric sensor is configured to capture a digital image of a fingerprint of a user of the payment card and/or is a biometric template generated from and corresponding to a digital image of a fingerprint of the user of the payment card.

10. The payment card of claim 1, wherein the biometric sensor includes an image capture sensor.

11. The payment card of claim 10, wherein the biometric sensor is configured to capture a digital image of an iris of a user of the payment card and/or is a biometric template generated from and corresponding to a digital image of an iris of the user of the payment card.
